(19) United States
(12) Patent Application Publication
(10) Pub. No.: US 2015/0088881 A1
(43) Pub. Date: Mar. 26, 2015

(54) Measuring Web Browser Tag Properties Without True Unique Tags

(71) Applicant: BLUECAVA, INC., Irvine, CA (US)

(72) Inventors: Andres Corrada, Watertown, MA (US); James Brentano, Orinda, CA (US)

(21) Appl. No.: 14/492,332

(22) Filed: Sep. 22, 2014

Related U.S. Application Data
(60) Provisional application No. 61/881,812, filed on Sep. 24, 2013.

(51) Int. Cl. G06F 17/30; G06N 7/00

(52) U.S. Cl. CPC G06F 17/3089; G06N 7/005
USPC 707/736

(57) ABSTRACT

Methods to estimate a statistic using web browser tags are disclosed. An exemplary method can include obtaining a data set of impressions. Each impression can be tagged with a first tag of a first type and a second tag of a second type different than the first type. A statistic of the data set of impressions can be estimated based at least in part on the first tag and the second tag of each impression. Computer systems and non-transitory computer readable media are also disclosed.

### CROSS-REFERENCE TO RELATED APPLICATIONS

The present application claims priority to U.S. Provisional Application No. 61/881,812, filed Sep. 24, 2013, the disclosure of which is hereby incorporated by reference in its entirety.

### BACKGROUND

1. Field of the Invention

The present disclosed subject matter relates generally to web browser tags and, more particularly, to methods, systems, and media to measure or infer statistical properties based on web browser tags.

2. Description of the Related Art

Online advertising technology can utilize unique tags for monitoring the amount of advertisements or impressions, as they can be known in the trade, that a unique web browser receives. In addition, a unique tag can be used to construct impression trails served on a particular browser, for example, to construct statistical models that can predict the future performance of advertising campaigns.

For purpose of illustration, a common unique tag in the industry is the cookie, which can be a small text file that can be deposited in a web browser as it interacts with online web sites. A cookie is not the only possible unique tag that can be created to build impression trails for web browsers. For example, other unique tagging technology can be employed.

Cookies and other unique tags can be prone to errors. For example and not limitation, a tag can incorrectly identify a previously identified web browser as a new web browser or as a different previously identified web browser. Additionally or alternatively, a tag can incorrectly identify a new web browser as a previously identified web browser. These errors can negatively impact the accuracy of statistics based on or modeled after these tags. Accordingly, there is a need for techniques to estimate statistics based on web browser tags.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, methods to estimate a statistic using web browser tags are disclosed. An exemplary method can include obtaining a data set of impressions. Each impression can be tagged with a first tag of a first type and a second tag of a second type different than the first type. A statistic of the data set of impressions can be estimated based at least in part on the first tag and the second tag of each impression.

In some embodiments, the statistic of the data set of impressions can include a number of unique web browsers in the data set of impressions. Estimating the statistic can include calculating the number of unique web browsers in the data set of impressions based at least in part on the first tag and the second tag of each impression. For purpose of illustration and not limitation, the first type can include a tag having an error rate p(new|previous) corresponding to incorrectly assigning a new tag to a previously seen web browser. For example, the first type can be a cookie. Additionally or alternatively, the second type can include a tag having error rates p(previous|new), p(new|previous), and p(other|previous) corresponding to incorrectly assigning a previous tag to a new web browser, incorrectly assigning a new tag to a previously seen web browser, and assigning an incorrect previous tag to a previously seen web browser, respectively. For example, the second type can be a BC ID,

For purpose of illustration and not limitation, calculating the number of unique browsers can include calculating using a plurality of normalizing equations and a plurality of observable event equations. For example, the plurality of normalizing equations can include at least one of a percentage of impressions provided to a new web browser plus a percentage of impressions provided to a previously seen web browser, a probability that the first tag correctly identified a new web browser with a new tag, a probability that the first tag correctly identified a previously seen web browser with a previous tag plus an error rate that the first tag incorrectly assigned a new tag to a previously seen web browser, a probability that the second tag correctly identified a new web browser with a new tag plus an error rate that the second tag incorrectly assigned a previous tag to a new web browser, or a probability that the second tag correctly identified a previously seen web browser with a previous tag plus error rates corresponding incorrectly assigning a new tag to a previously seen web browser and assigning an incorrect previous tag to a previously seen web browser. Additionally or alternatively, the plurality of observable event equations can include at least one of a probability that the first tag and the second tag both identified a web browser with a new tag, a probability that the first tag identified a web browser with a new tag when the second tag identified the web browser with a previous tag, a probability that the first tag identified a web browser with a previous tag when the second tag identified the web browser with a new tag, a probability that the first tag and the second tag both identified a web browser with a previous tag, a percentage of impressions where the first tag and the second tag both correctly identify a previously seen web browser with a previous tag, or a percentage of impressions where the second tag identified a web browser with a new tag.

In accordance with another aspect of the disclosed subject matter, computer systems are disclosed. An exemplary computer system can include at least one processor. At least one computer readable medium can be operatively coupled to the at least one processor. A logic can (i) execute in the at least one processor from the at least one computer readable medium and (ii) when executed by the at least one processor, cause the computer system to estimate a statistic. For purpose of illustration and not limitation, the logic can include obtaining a data set of impressions. Each impression can be tagged with a first tag of a first type and a second tag of a second type different than the first type. A statistic of the data set of impressions can be estimated based at least in part on the first tag and the second tag of each impression. For example and not limitation, the statistic of the data set of impressions can include a number of unique web browsers in the data set of impressions, and estimating a statistic can include calculate the number of unique web browsers in the data set of impressions based at least in part on the first tag and the second tag of each impression.

In accordance with another aspect of the disclosed subject matter, non-transitory computer readable storage media are disclosed. An exemplary non-transitory computer readable storage medium can include a set of executable instructions. The executable instructions can direct a processor to obtain a data set of impressions. Each impression can be tagged with a first tag of a first type and a second tag of a second type different than the first type. A statistic of the data set of impressions can be estimated based at least in part on the first tag and the second tag of each impression. For purpose of illustration and not limitation, the statistic of the data set of impressions can include a number of unique web browsers in the data set of impressions, and estimating a statistic can include calculating the number of unique web browsers in the data set of impressions based at least in part on the first tag and the second tag of each impression.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

Other systems, methods, features and advantages of the disclosed subject matter will be or will become apparent to one with skill in the art upon examination of the following figures and detailed description. It is intended that all such additional systems, methods, features, and advantages be included within this description, be within the scope of the disclosed subject matter, and be protected by the accompanying claims. Component parts shown in the drawings are not necessarily to scale, and may be exaggerated to better illustrate the important features of the disclosed subject matter. In the drawings, like reference numerals designate like parts throughout the different views, wherein:

FIG. 1 is a process flow chart illustrating an exemplary method to estimate a statistic using web browser tags according to an illustrative embodiment of the disclosed subject matter.

FIG. 2 is a process flow chart illustrating an exemplary method to calculate a number of unique web browsers in a data set of impressions according to an illustrative embodiment of the disclosed subject matter.

FIG. 3 is a block diagram of an exemplary computer system according to an illustrative embodiment of the disclosed subject matter.

FIG. 4 is a pictorial block diagram of an exemplary modem communications network in which the present disclosed subject matter may be implemented.

It is to be understood that the attached drawings are for purposes of illustrating the concepts of the disclosed subject matter and are not intended to be limiting in terms of the range of possible shapes and/or proportions.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, systems, and media presented herein can be used for estimating a statistic using web browser tags. The disclosed subject matter is particularly suited for estimating a statistic using two web browser tags, for example, calculating a number of unique web browsers in a data set of impressions based at least in part on a first tag and a second tag of each impression.

In accordance with the disclosed subject matter herein, a method to estimate a statistic using web browser tags are disclosed. An exemplary method can include obtaining a data set of impressions. Each impression can be tagged with a first tag of a first type and a second tag of a second type different than the first type. A statistic of the data set of impressions can be estimated based at least in part on the first tag and the second tag of each impression.

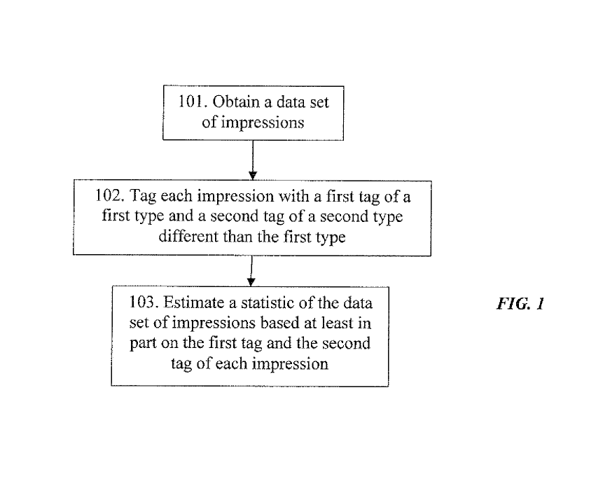

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, exemplary embodiments of methods, systems, and media to estimate a statistic using web browser tags in accordance with the disclosed subject matter are shown in FIGS. 1-4. While the present disclosed subject matter is described with respect to using the methods, systems, and media for estimating a statistic using web browser tags, one skilled in the art will recognize that the disclosed subject matter is not limited to the illustrative embodiments. For example, the methods, systems, and media for estimating a statistic using web browser tags can be used with a wide variety of settings such as websites, computer applications (“apps”), smartphone apps, tablet apps, apps for other mobile devices, and other suitable settings for estimating a statistic using web browser tags.

FIG. 1 presents a process flow chart illustrating an exemplary method to estimate a statistic using web browser tags according to an illustrative embodiment of the disclosed subject matter. An exemplary method can include obtaining a data set of impressions (101). The data set of impressions can include, e.g., time stamps corresponding to each impression and any other suitable information pertaining to the impressions as discussed herein. For example and not limitation, the other information could include web browser tags, the type of device, or the operation system (e.g. Windows or Mac) corresponding to each impression, as discussed herein. In some embodiments, the data set can be obtained in real time, for example, from devices connected to a network as discussed herein. Additionally or alternatively, the data for the data set can come from a memory and/or mass storage, as discussed herein.

Each impression can be tagged with a first web browser tag of a first type and a second web browser tag of a second type different than the first type (102). For purpose of illustration and not limitation, the web browser tags can be prone to errors. For example and not limitation, the first type of browser tag can be prone to errors corresponding to incorrectly assigning a new tag to a previously seen web browser, as discussed herein. Additionally, the second type of browser tag can be prone to errors in the same and/or different situations as the first type of browser tag. For example and not limitation, the second type of browser tag can be prone to errors corresponding to incorrectly assigning a previous tag to a new web browser, incorrectly assigning a new tag to a previously seen web browser, and assigning an incorrect previous tag to a previously seen web browser, as discussed herein. The errors associated with each of the first type and second type of browser tags can occur at the same or different rates. Additionally, in some embodiments, the rate at which errors occur can be unknown for either or both types of browser tags.

A statistic of the data set of impressions can be estimated based at least in part on the first tag and the second tag of each impression (103). For purpose of illustration and not limitation, a system of equations can be used to calculate the statistic based on a plurality of variables. For example and not limitation, a number of equations to be used can be greater than or equal to the number of variables, as discussed herein. Additionally, the equations used can include, but are not limited to, equations in which the sum of probabilities of possible events equals one (referred to as “normalization equations”) and equations in which the sum or probabilities of possible events corresponds to a percentage of observed events (referred to as “observable event equations”), as described herein.

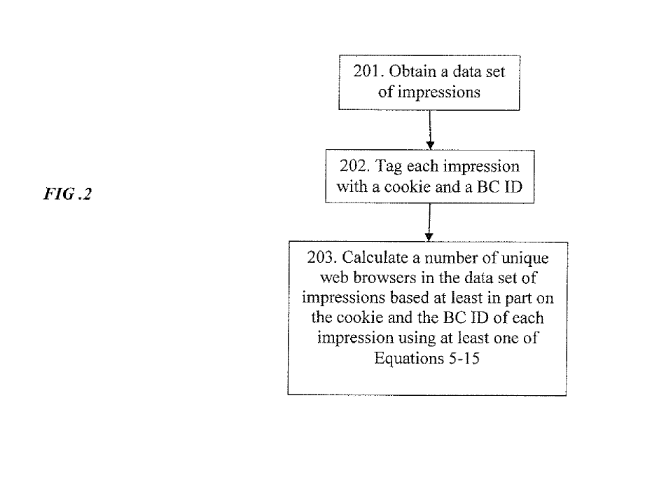

For purpose of illustration and not limitation, the statistic of the data set of impressions can include a number of unique web browsers in the data set of impressions. FIG. 2 is a process flow chart illustrating an exemplary method to calculate a number of unique web browsers in a data set of impressions according to an illustrative embodiment of the disclosed subject matter. With reference to FIG. 2, a statistical methodology for calculating a number of unique web browsers in the data set of impressions based at least in part on at least two different browser tags for each impression is detailed. For example and not limitation, the first tag can be a cookie, and a second tag can be a different type of browser tag. For purpose of illustration, the second tag can be a unique tag, such as the BlueCava BC ID as disclosed in U.S. Pat. No. 8,601,109; U.S. patent application Ser. Nos. 14/036,547 and 14/036,578 filed Sep. 25, 2013; and U.S. patent application Ser. No. 14/127,871 filed Dec. 19, 2013, all of which are fully incorporated herein by reference. As discussed herein, statistical properties of the accuracy of each type of tag in identifying unique web browsers can be inferred. In addition, the true number of unique web browsers observed in an impression data set can be statistically inferred. These statistical estimates can be obtained without advance knowledge of the true unique identification of the web browsers associated with the impressions in the data set and without advance knowledge of the error rate of the browser tags.

A data set of impressions can be obtained (201). For example and not limitation, the impressions data can be obtained in real time, as discussed herein, e.g., during an advertising campaign. Additionally or alternatively, data can be obtained from a memory or storage. For purpose of illustration and not limitation, an impression data set can be in the form detailed in Table 1.

Each impression in the data set can be tagged with a first tag of a first type, e.g., a cookie, and a second tag of a second type different than the first type, e.g., a BC ID (202). As embodied herein, the disclosed subject matter can be used to infer the percentage of times cookies correctly assign unique tags to browser apps and the percentage of times that BC IDs correctly assign unique tags to the same impression data. Additionally or alternatively, the disclosed subject matter can be used to infer the percentage of true unique web browsers in the impression dataset.

For purpose of illustration and not limitation, the statistical quantity of interest can be the number of unique web browsers in the impression data stream. The number of unique web browsers can correspond to the number of first impressions shown to the web browsers. The relation between first impressions, recurring impressions and total impressions shown can be given by Equation 1.

#{total impressions}=#{first impressions}+#{recurring impression} (1)

The number of total impressions can be directly measurable from the total number of rows in the impression data set. The individual counts on the right side of Equation 1 (i.e. the number of first impressions and the number of recurring impressions) can be unknown.

TABLE 1
Format for the impression dataset assumed here.

| timestamp | cookie ID | BC AppBrowser ID |
|---|---|---|
| 10 | c1234 | b2323 |
| 12 | c4321 | b4532 |
| . | . | . |
| . | . | . |
| . | . | . |

The relation between unique and recurring impressions can be expressed by dividing Equation 1 by the total number of impressions in the impression dataset. This can be shown in Equation 2.

$$\frac{\# \{ first impressions \}}{\# \{ total impressions \}} + \frac{\# \{ recurring impressions \}}{\# \{ total impressions \}} = 1 \qquad ( 2 )$$

Two unknown statistical quantities can be defined from Equation 2. First, the percentage of impressions that were served to web browsers for the first time denoted by the symbol P (new)

$$P ( new ) = \frac{\# \{ first impressions \}}{\# \{ total impressions \}} \qquad ( 3 )$$

Second, the percentage of impressions that were recurring on web browsers previously seen, denoted by the symbol P (previous),

$$P ( previous ) = \frac{\# \{ recurring impressions \}}{\# \{ total impressions \}} \qquad ( 4 )$$

The mathematical relationship between these two unknown percentages can be given by Equation 5

P(new)+P(previous)=1 (5)

Equation 5 can be a first equation that can be used in accordance with the disclosed subject matter to estimate the numerical value of P (new) and P (previous) for any given impression dataset.

In addition, the statistics of interest can include the accuracy and errors of the two web browser tags, for example, cookies and BC IDs, and the disclosed subject matter can be used to estimate these quantities. Accordingly, the foregoing and following equations can be used to estimate any or all of the number of unique web browsers in an impression data set, the accuracy and errors of cookies, and the accuracy and errors of BC IDs.

Cookies can be implemented such that, whenever a new web browser is observed in an impression data set (e.g. during an advertising campaign), the cookie setting mechanism can correctly recognize the new web browser and assign a new unique tag to the web browser. This can be expressed mathematically by Equation 6,

p_{cookie}(new|new)=1 (6)

Equation 6 can be a second equation that can be used to deduce all unknown statistical quantities from the impression data stream.

Cookies can make errors as a unique tagger by incorrectly assigning a new unique tag to previously seen web browsers. This error rate can be denoted by the symbol p_{cookie}(new|previous), and the rate of correctly assigning the same unique tag to previously seen web browsers can be denoted as p_{cookie}(previous|previous). Equation 7, which can be a third equation used to estimate the statistical quantities, can give the relationship between these two rates.

P_{cookie}(previous|previous)+p_{cookie}(new|previous) (7)

The BC ID can have different accuracies and errors than a cookie. For example and not limitation, when a BC ID encounters a new web browser, there can be two possibilities. First, the BC ID can correctly identify the web browser as new and gives it a new unique tag. Second, the BC ID can mistakenly identify the web browser as a previously seen web browser and assign it the tag of that previous browser. The relationship between these two cases for a new web browser can be shown in Equation 8.

P_{BC}(new|new)+p_{BC}(previous|new)=1 (8)

Additionally, the BC ID can encounter a previously seen web browser that reappears in the impression data stream. There can be three possibilities in this scenario: (1) the BC ID can correctly recognize that it saw the web browser before and give it the same previous tag; (2) the BC ID can incorrectly tag the browser as new; or (3) the BC ID can tag the impression with the identification of another, incorrect previously seen browser. The relationship between these quantities can be shown in Equation 9.

p_{BC}(previous|previous)+p_{BC}(new|previous)+p_{BC}(other|previous)=1 (9)

The aforementioned statistic quantities and other statistical quantities that can be measured with the disclosed subject matter can include the quantities listed in Table 2. For purpose of illustration and not limitation, the statistics in Table 2 can be estimated or calculated using the information contained in impression data streams of the form in Table 1.

TABLE 2
List of statistical quantities that can be inferred using
the methodology of the disclosed subject matter.

| statistical quantity | symbol |
|---|---|
| percentage of impressions to new browsers | P (new) |
| percentage of impressions to previous | P (previous) |
| browsers | |
| probability cookie correctly identifies new | p_{cookie}(new \| new) |
| browser | |
| probability cookie correctly identifies | p_{cookie}(previous \| previous) |
| previous browser | |
| probability cookie wrongly identifies | p_{cookie}(new \| previous) |
| previous browser as new | |
| probability BC ID correctly identifies new | p_{BC}(new \| new) |
| browser | |
| probability BC ID wrongly identifies new | p_{BC}(previous \| new) |
| browser as previous | |
| probability BC ID correctly identifies | p_{BC}(previous \| previous) |
| previous browser | |
| probability BC ID wrongly identifies | p_{BC}(new \| previous) |
| previous browser as new | |
| probability BC ID wrongly identifies | p_{BC}(other \| previous) |
| previous browser as another | |

Table 2 can show ten quantities that can be estimated. To estimate ten statistics (i.e. unknown variables), ten or more equations can be used. For purpose of illustration and not limitation, Equations 5-9 can be used to estimate these statistics. Additionally, at least five more equations can be used to solve for these unknown quantities. Accordingly, for example and not limitation, Equations 5-9 can be used with the following equations to solve for all ten statistical quantities.

As embodied herein, the impression data stream can be used to count four observable events. Starting with the first impression and proceeding forward in time, the number of times each of the following events occur can be counted:
The event where both the cookie tag and the BC ID tag are observed for the first time (i.e. new) in the impression stream.
The event where the cookie tag is seen for the first time (i.e. new), but the BC ID tag appeared previously.
The event where the cookie tag appeared previously, but the BC ID tag is observed for the first time (i.e. new).
The event where the cookie and BC ID tags were both previously seen in the impression stream.
   These event counts can be divided by the total number of impressions to give a percentage frequency of occurrence for each of the events. Assuming that the cookie and BC ID are making independent errors, these four observable event frequencies can be written in terms of the unknown statistical quantities as follows.

The percentage of times that both the cookie tag and BC ID tag is observed for the first time can be equal to the number of times both the cookie and BC ID correctly identified a new web browser plus the number of times they both got it wrong, Equation 10

P(new)p_{cookie}(new|new)p_{BC}(new|new)+P(previous)p_{cookie}(new|previous)p_{BC}(new|previous)=f(new, new) (10)

The percentage of times an impression is identified with a new cookie tag and a previous BC ID tag can be equal to the number of times the cookie is right but the BC ID is wrong plus the number of times the BC ID is right and the cookie is wrong plus the number of times the BC ID wrongly assigns a previous unique tag and the cookie is wrong, Equation 11.

P(new)p_{cookie}(new|new)p_{BC}(previous|new)+P(previous)p_{cookie}(new|previous)p_{BC}(previous|previous)+P(previous)p_{cookie}(new|previous)p_{BC}(other|previous)=f(new, previous) (11)

The percentage of times an impression is identified with a previous cookie tag and a new BC ID tag can be equal to the number of times the cookie is right and BC ID wrong. This can be expressed in Equation 12.

P(previous)p_{cookie}(previous|previous)p_{BC}(new|previous)=f(previous, new) (12)

The percentage of times both the cookie and BC ID tag were seen previously in the impression stream can be composed of two underlying true events: the number of times the cookie and the BC ID both are right plus the number of times the cookie is right but the BC ID tagged the impression as another previous browser.

P(previous)p_{cookie}(previous|previous)(p_{BC}(previous|previous)+p_{BC}(other|previous))=f(previous, previous) (13)

Equations 5-13 can include nine equations. To solve for ten statistical quantities, the number of total equations can be at least ten. Accordingly at least one more equation can be used. For purpose of illustration and not limitation, two more equations can be used. For example, these equations can be obtained by transforming the impression stream by using one or the other type of browser tag to align the impressions. For purpose of illustration, the cookie tag can be used to transform the impression stream into a series of impression trails. Each impression trail can correspond to a single cookie tag and a series of impressions ordered forward in time for each trail. Additionally or alternatively, the impression stream can be transformed to creating an impression trail for each unique BC ID. As shown in Equations 14 and 15, each of the aforementioned transformations can result in organizing the impression data to give a different equation. Together with Equations 9-13, the following two equations can be used to solve for all ten unknown statistical quantities in Table 2.

An equation corresponding to aligning the impression data by cookie tag can be given by counting the number of times that successive impressions for the same cookie have a BC ID tag in agreement. This can occur when both the cookie and the BC ID each correctly identify the impression as corresponding to a previously observed web browser. This relationship can be shown in Equation 14.

$$P ( previous ) {p}_{cookie} ( previous \vert previous ) {p}_{BC} ( previous \vert previous ) = \frac{\# \{ BC IDs agree on successive same cookie impressions \}}{\# \{ total impressions \}} \qquad ( 14 )$$

Additionally or alternatively, an equation corresponding to aligning impressions by BC ID tag can be given by counting the number of impression trails, which can correspond to the number of unique BC IDs recorded in the data stream. This number can be equal to the number of times the BC ID was correct plus the number of times the BC ID incorrectly identified a previously observed browser as a new one, which can be shown in Equation 15.

$$p ( new ) {p}_{BC} ( new \vert new ) + P ( previous ) {p}_{BC} ( new \vert previous ) = \frac{\# \{ number BC unique IDs \}}{\# \{ total impressions \}} \qquad ( 15 )$$

For purpose of illustration and not limitation, the aforementioned equations can be tested by carrying out the simultaneous solution of the eleven equations detailed above (e.g. five normalization Equations 5-9 and six observable event Equations 10-15) on an exemplary impression stream corresponding to impression data obtained during an advertising campaign. Exemplary observed counts for this exemplary impression data set can be shown in Table 3.

TABLE 3
Observed counts in an actual impression stream for
an advertising campaign that ran for two weeks.

| count type | count |
|---|---|
| total impressions | 107187864 |
| number impressions with cookie ID and BC ID new | 5484113 |
| number impressions with cookie ID, BC ID previous | 904149 |
| number impressions with cookie ID previous, BC ID new | 658822 |
| number impressions with cookie ID and BC ID previous | 92003432 |
| number cookie aligned impressions where consecutive | 91748960 |
| BC IDs agree | |
| number of unique BC IDs | 6142935 |

The equations enumerated above can be set up with the counts from Table 3 to create a system of eleven cubic equations. These equations can be solved by any suitable technique. For example and not limitation, they can be solved simultaneously with any suitable algebraic solver software. For purpose of illustration and not limitation, the equations can be solved using Mathematica Solve function, and the results can be shown in Table 4.

TABLE 4
Estimated values for the statistical quantities
related to the campaign detailed in Table 3.

| statistical quantity | estimate |
|---|---|
| P (previous) | 0.949076 |
| P (new) | 0.050924 |
| p_{cookie}(new \| new) | 1 |
| p_{cookie}(previous \| previous) | 0.91087 |
| p_{cookie}(new \| previous) | 0.0891301 |
| p_{BC}(new \| new) | 0.99289 |
| p_{BC}(previous \| new) | 0.00711 |
| p_{BC}(previous \| previous) | 0.990144 |
| p_{BC}(new \| previous) | 0.00710993 |
| p_{BC}(other \| previous) | 0.00274623 |

To validate that the empirical values are not in a region of parameter space that yields unstable answers, a series of synthetic data sets can be produced using as inputs the values estimated in Table 4. This can give an indirect measure of the expected error in the estimated values. For purpose of illustration and not limitation, synthetic datasets can be created to have the same number of total impressions and with each tagger having the average performance as in Table 4. The resulting synthetic data can have similar event counts, and the counts can fluctuate in each synthetic set produced from the true inputs provided due to the finite size of each set. For example and not limitation, the results of all the simulated sets can validate that for a large set of impressions, e.g. 107 million impressions, the statistical quantities can be estimated with better than one part in a thousand accuracy. A greater or lesser number of impressions can be used for such a simulated data set as desired, for example, to assess the accuracy corresponding to a larger or smaller data set, respectively. In some exemplary cases, the accuracy can be better than one part in a million (e.g. for the prevalence parameters P (new) and P (previous)).

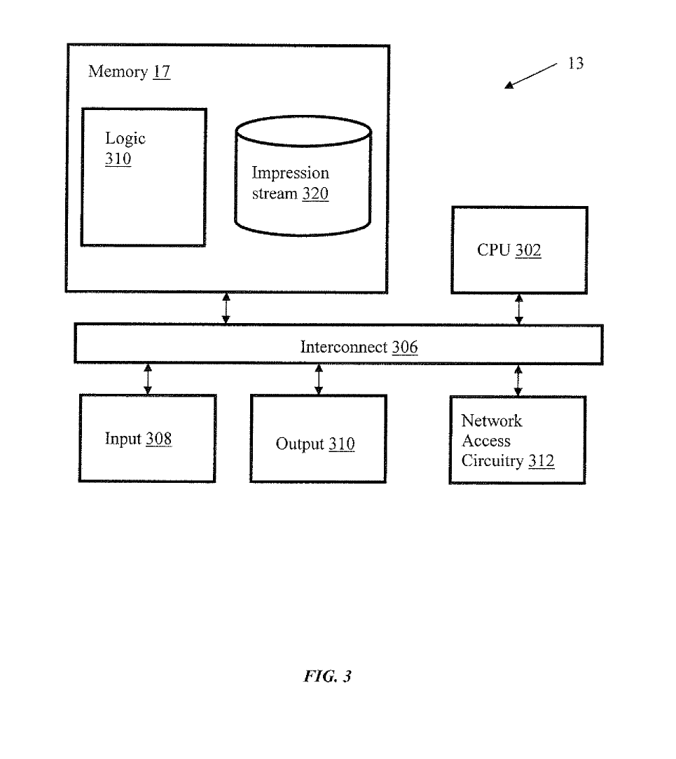

With reference to FIG. 3, an exemplary computer system 13 according to an illustrative embodiment of the disclosed subject matter can include one or more microprocessors 302 (collectively referred to as CPU 302) that can retrieve data and/or instructions from memory 17 and execute retrieved instructions in a conventional manner. Memory 17 can include generally any computer-readable medium including, for example, persistent memory such as magnetic and/or optical disks, ROM, and PROM, and volatile memory such as RAM.

CPU 302 and memory 17 can be connected to one another through a conventional interconnect 306, which can be a bus in some illustrative embodiments and which can connect CPU 302 and memory 17 to one or more input devices 308, output devices 310, and network access circuitry 312. Input devices 308 can include, for example and not limitation, a keyboard, a keypad, a touch-sensitive screen, a mouse, and a microphone. Output devices 210 can include, for example and not limitation, a display—such as a liquid crystal display (LCD)—and one or more loudspeakers. In some embodiments of computer system 13, input devices 308 and/or output devices 310 can be omitted. For example and not limitation, the input devices 308 and output devices 310 can be omitted when the computer system 13 comprises a server, as further described herein. Network access circuitry 312 can send and receive data through wide area network such as the Internet and/or mobile device data networks, as discussed herein.

A number of components of computer system 13 can be stored in memory 17. For purpose of illustration and not limitation, logic 310 can be all or part of one or more computer processes executing within CPU 302 from memory 17 in some illustrative embodiments. Additionally or alternatively, logic 310 can be implemented using digital logic circuitry. As used herein, “logic” can refer to (i) logic implemented as computer instructions and/or data within one or more computer processes, and/or (ii) logic implemented in electronic circuitry. Impression stream 320 can be data stored persistently in memory 17. For example and not limitation, impression stream 320 can be organized as a database. Additionally or alternatively, the impression stream and be obtained from a network via network access circuitry 312 and/or stored on a remote memory or storage, as discussed herein.

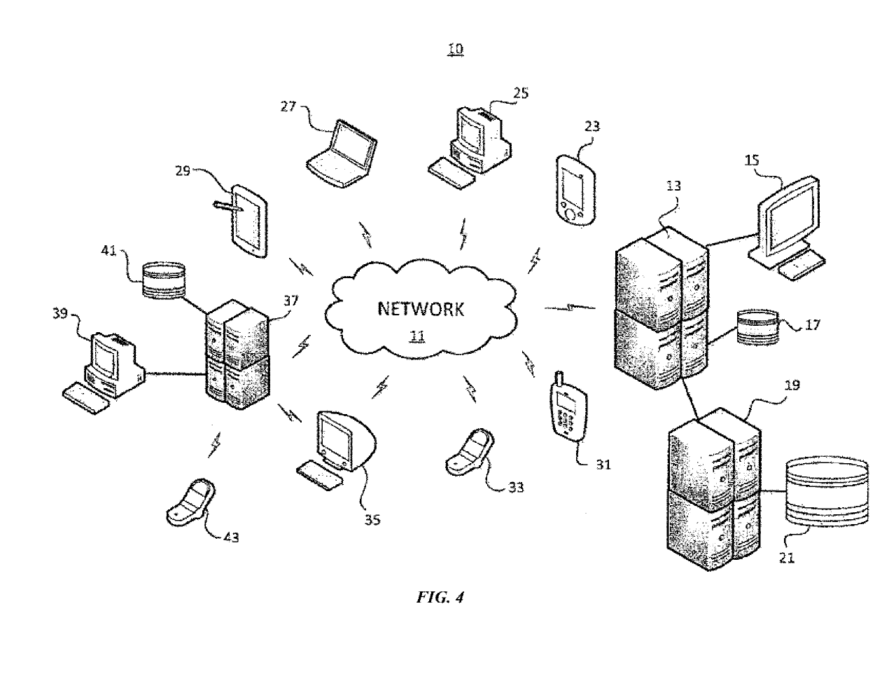

For purpose of illustration and not limitation, computing devices for which statistics may be estimated using web browser tags include any device capable of receiving resources remotely through a network connection. FIG. 4 illustrates many such devices connected in a modern network communications system 10. System 10 represents but one example of a network within which the present disclosed subject matter may be practiced.

System 10 can include a network cloud 11, which can represent a combination of wired and wireless communication links between devices that make up the rest of the system. The communication links of network 11 can run from any device to any other device in the network, and can include any means or medium by which analog or digital signals can be transmitted and received, such as radio waves at a selected carrier frequency modulated by a signal having information content. Network 11 can include telecommunication means such as cellular communication schemes, telephone lines, and broadband cable. The communication means of network 11 can also include any conventional digital communications protocol, or any conventional analog communications method, for transmitting information content between computing devices. In some embodiments, or for ease of illustration, network 11 can be considered to be synonymous with the Internet.

Estimating a statistic based on web browser tags for any device connected to network 11 can be performed by running an executable set of instructions, also known as code, on the same or a different connected device. The executable instructions can be stored on any device or number of devices; however, for purposes of illustration and not limitation, throughout the remainder of this disclosure embodiments of the disclosed subject matter are described in which the code can be stored primarily on a single computer system, e.g. application server 13. When authorized or requested by a user of any other device connected to network 11, the code may be transferred from application server to the requesting device for execution thereon and for temporary or secondary storage therein. For example, the code may be run in a web browser of the device being fingerprinted.

Application server 13 can be a special-purpose computer system that can include a set of hardware and software components dedicated to the execution and distribution of the code. Application server 13 can be configured for network communications, i.e., for transmitting and receiving resource requests to and from other devices linked to network 11, and can include a web server to facilitate network communications. Application server 13 can also be configured to perform other functions conventionally associated with application servers, such as security, redundancy, fail-over, and load-balancing. A user interface 15 can provide user or administrator access to data processed by the application server, or to the software components that make up the application server. Memory 17 can store operating system, web server, code, and other data or executable software stored on application server 13.

A database server 19 can be linked for data communication with application server 13. Database server 19 can be a special purpose computer system that can include hardware and software components dedicated to providing database services to application server 13. Database server 19 can interface with memory 21, which can be a large-capacity storage system. In one implementation of estimating a statistic using web browser tags according to the disclosed subject matter, memory 21 can be a main repository or historical archive for storing one or more impression data sets communicating, or having once communicated, through network 11.

Any computing device capable of receiving digital information via network 11 can be subject to estimating a statistic using web browser tags according to the disclosed subject matter. System 10 can provide a representative group of such devices for purposes of illustrating exemplary embodiments of the disclosed subject matter, but the disclosed subject matter is by no means limited to the number and type of devices shown in FIG. 1. Examples of devices known today for which a statistic can be estimated using web browser tags can include, but are not limited to, a personal digital assistant (PDA) 23, a personal computer (PC) 25, a laptop 27, a tablet 29, a smart phone 31, a cell phone 33, and an Apple computer 35, as shown, all or any of which may be configured for direct or indirect communication via network 11. Any device in the preceding list of devices can be referred to as a computer system, a computing device, a client device, a requesting device, or a receiving device.

A server 37 may also constitute a computing device subject to estimating a statistic using web browser tags. Moreover, each device among a group of devices configured to communicate locally with server 37, and to access network 11 via server 37, can potentially be used for estimating a statistic using web browser tags. These can include, for example, the Apple computer 35, a PC 39, and a cell phone 43, as shown. Server 37 can be any type of server, such as an application server, a web server, or a database server, and may access a memory 41. In some embodiments, the server 37 can provide a web page accessible through network 11 by other devices. The web page may provide information such as text, graphics, data structures, audio, video and computer applications that are stored as digital data in memory 41 for downloading or streaming via network 11.

The methods described herein may be implemented on a variety of communication hardware, processors and systems known by those of ordinary skill in the computing arts. The various diagrams and flow charts described in connection with the embodiments disclosed herein may be implemented or performed in full or in part with a general purpose processor, digital signal processor, application specific integrated circuit, field programmable gate array, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller or state machine. A processor may also be implemented as a combination of any of the aforementioned computing devices.

The steps of a method, process, program, or algorithm described in connection with the embodiments disclosed herein may be embodied directly in hardware, in a software module executable by a processor, or in a combination of the two, e.g. as firmware. A software module may reside in memory such as RAM, ROM, EPROM, EEPROM, flash memory, registers, a hard disk, a removable disk, a CD-ROM, or another software module such as a web browser, or within any other form of storage medium known in the art for recording digital data. An exemplary storage medium may be coupled to the processor, such that the processor can read information from, and write information to, the storage medium. In the alternative, the storage medium may be integral to the processor. In a pure form, a method according to the disclosed subject matter may be software embodied as an electronic signal or series of electronic signals capable of being transmitted as information wirelessly or otherwise, for example, as a modulating signal receivable through a modem as a downloadable file or bit stream.

Exemplary embodiments of the disclosed subject matter have been disclosed in an illustrative style. Accordingly, the terminology employed throughout should be read in an exemplary rather than a limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method to estimate a statistic using web browser tags, comprising:
obtaining a data set of impressions;
tagging each impression with a first tag of a first type and a second tag of a second type different than the first type; and
estimating a statistic of the data set of impressions based at least in part on the first tag and the second tag of each impression.

2. The method of claim 1, wherein the statistic of the data set of impressions comprises a number of unique web browsers in the data set of impressions, and wherein estimating a statistic comprises calculating the number of unique web browsers in the data set of impressions based at least in part on the first tag and the second tag of each impression.

3. The method of claim 2, wherein the first type comprises a tag having an error rate corresponding to incorrectly assigning a new tag to a previously seen web browser.

4. The method of claim 3, wherein the first type comprises a cookie.

5. The method of claim 2, wherein the second type comprises a tag having error rates corresponding to incorrectly assigning a previous tag to a new web browser, incorrectly assigning a new tag to a previously seen web browser, and assigning an incorrect previous tag to a previously seen web browser, respectively.

6. The method of claim 5, wherein the second type comprises a unique tag.

7. The method of claim 2, wherein calculating the number of unique browsers comprises calculating using a plurality of normalizing equations and a plurality of observable event equations.

8. The method of claim 7, wherein the plurality of normalizing equations comprises at least one of:
a percentage of impressions provided to a new web browser plus a percentage of impressions provided to a previously seen web browser;
a probability that the first tag correctly identified a new web browser with a new tag;
a probability that the first tag correctly identified a previously seen web browser with a previous tag plus an error rate that the first tag incorrectly assigned a new tag to a previously seen web browser;
a probability that the second tag correctly identified a new web browser with a new tag plus an error rate that the second tag incorrectly assigned a previous tag to a new web browser;
a probability that the second tag correctly identified a previously seen web browser with a previous tag plus error rates corresponding incorrectly assigning a new tag to a previously seen web browser and assigning an incorrect previous tag to a previously seen web browser.

9. The method of claim 7, wherein the plurality of observable event equations comprises at least one of:
a probability that the first tag and the second tag both identified a web browser with a new tag;
a probability that the first tag identified a web browser with a new tag when the second tag identified the web browser with a previous tag;
a probability that the first tag identified a web browser with a previous tag when the second tag identified the web browser with a new tag;
a probability that the first tag and the second tag both identified a web browser with a previous tag;
a percentage of impressions where the first tag and the second tag both correctly identify a previously seen web browser with a previous tag; and
a percentage of impressions where the second tag identified a web browser with a new tag.

10. A computer system, comprising:
at least one processor;
at least one computer readable medium that is operatively coupled to the at least one processor; and
a logic that (i) executes in the at least one processor from the at least one computer readable medium and (ii) when executed by the at least one processor, causes the computer system to estimate a statistic by at least:
obtaining a data set of impressions;
tagging each impression with a first tag of a first type and a second tag of a second type different than the first type; and
estimating a statistic of the data set of impressions based at least in part on the first tag and the second tag of each impression.

11. The computer system of claim 10, wherein the statistic of the data set of impressions comprises a number of unique web browsers in the data set of impressions, and wherein estimate a statistic comprises calculate the number of unique web browsers in the data set of impressions based at least in part on the first tag and the second tag of each impression.

12. The computer system of claim 11, wherein the first type comprises a tag having an error rate corresponding to incorrectly assigning a new tag to a previously seen web browser.

13. The computer system of claim 12, wherein the first type comprises a cookie.

14. The computer system of claim 11, wherein the second type comprises a tag having error rates corresponding to incorrectly assigning a previous tag to a new web browser, incorrectly assigning a new tag to a previously seen web browser, and assigning an incorrect previous tag to a previously seen web browser, respectively.

15. The computer system of claim 14, wherein the second type comprises a unique tag.

16. The computer system of claim 11, wherein calculating the number of unique browsers comprises calculating using a plurality of normalizing equations and a plurality of observable event equations.

17. The computer system of claim 16, wherein the plurality of normalizing equations comprises at least one of:
a percentage of impressions provided to a new web browser plus a percentage of impressions provided to a previously seen web browser;
a probability that the first tag correctly identified a new web browser with a new tag;
a probability that the first tag correctly identified a previously seen web browser with a previous tag plus an error rate that the first tag incorrectly assigned a new tag to a previously seen web browser;
a probability that the second tag correctly identified a new web browser with a new tag plus an error rate that the second tag incorrectly assigned a previous tag to a new web browser;
a probability that the second tag correctly identified a previously seen web browser with a previous tag plus error rates corresponding incorrectly assigning a new tag to a previously seen web browser and assigning an incorrect previous tag to a previously seen web browser.

18. The computer system of claim 16, wherein the plurality of observable event equations comprises at least one of
a probability that the first tag and the second tag both identified a web browser with a new tag;
a probability that the first tag identified a web browser with a new tag when the second tag identified the web browser with a previous tag;
a probability that the first tag identified a web browser with a previous tag when the second tag identified the web browser with a new tag;
a probability that the first tag and the second tag both identified a web browser with a previous tag;
a percentage of impressions where the first tag and the second tag both correctly identify a previously seen web browser with a previous tag; and
a percentage of impressions where the second tag identified a web browser with a new tag.

19. A non-transitory computer readable storage medium comprising a set of executable instructions to direct a processor to:
obtain a data set of impressions;
tag each impression with a first tag of a first type and a second tag of a second type different than the first type; and
estimate a statistic of the data set of impressions based at least in part on the first tag and the second tag of each impression.

20. The non-transitory computer readable storage medium of claim 19, wherein the statistic of the data set of impressions comprises a number of unique web browsers in the data set of impressions, and wherein estimate a statistic comprises calculate the number of unique web browsers in the data set of impressions based at least in part on the first tag and the second tag of each impression.
